(19) United States
(12) Patent Application Publication
(10) Pub. No.: US 2021/0386140 A1
(43) Pub. Date: Dec. 16, 2021

(54) MULTIPLE USE FACE SEAL MASK

(71) Applicant: ZMASK, INC., Henderson, NW (US)

(72) Inventors: Wendell BROWN, Henderson, NV (US); Alec GELLIS, Henderson, NV (US)

(73) Assignee: ZMASK, INC., Henderson, NV (US)

(21) Appl. No.: 17/070,230

(22) Filed: Oct. 14, 2020

Related U.S. Application Data
(60) Provisional application No. 63/038,876, filed on Jun. 14, 2020.

(51) Int. Cl. A41D 13/11

(52) U.S. Cl. CPC A41D 13/1176

(57) ABSTRACT

A facial mask completely seals a part of the face over which the facial mask is secured by an adhesive around a periphery of the facial mask. The facial mask may cover the mouth or both the mouth and nose of a user. The facial mask may have a filter.

### RELATED APPLICATIONS

This application claims the benefit of U.S. Provisional Application No. 63/038,876, filed Jun. 14, 2020, and which is incorporated herein by reference.

### FIELD

The disclosure relates generally to a multiple use mask for covid-19 protections and in particular to a complete face seal multiple use mask.

### BACKGROUND

Facial masks are common in various medical settings to reduce the spread of disease, in the building construction trades to reduce breathing intake of dust or fumes, and in travel and other scenarios to reduce contagious disease spread. Currently, due to the covid-19 pandemic, people are wearing various types of masks designed to prevent droplets containing the virus from gaining access to the nasal passages or mouth of a user. Many people are wearing or required to wear facial masks while at work, shopping, and walking outside and many other non-medical situations. Some people were required or voluntarily wore facial masks for extended times—sometimes for multiple hours and sometimes for 8+ hours per day.

Facial masks have typically been constructed using elastic straps which loop around the ears or the back of the head to hold the mask itself against the face. This design can result in wearers suffering back-of-the-ear irritations, where the elastic straps irritate the skin behind the ears. The straps often can become uncomfortable, especially for extended-time wearers or every-day wearers. Facial masks which are held against the face by ear straps often have “air gaps” around the edge of the mask, allowing unfiltered air to enter in or out of the wearer. One solution has been to pull the mask tighter against the face, which does create a better seal/smaller gaps, however wearing a tight face masks typically makes the face mask less comfortable to wear and can leave impression marks in the skin.

Thus, the problem with most of these masks is that they do not create a complete facial seal meaning that the virus can still exit or enter the mask because there is not a complete facial seal. Furthermore, most of these masks use straps that go around the ears of the user or the back of the head of the user which is uncomfortable and results in people removing the mask at the wrong times (such as when still inside in an enclosed area with a large number of other people) or not wearing the mask at all. Thus, it is desirable to provide a mask that do not require straps and seals the face.

There have been other uses for an adhesive to adhere an item to the skin of the user. For example, nasal strips meant to open the nasal passages or strapless brassieres use some form of adhesive to adhere to the skin pull the skin up on the nose and thus open the nasal passages. The adhesive on a strapless brassiere adheres to the skin and keeps the brassiere up and covering the breasts of the wearer. None of the uses however, have contemplated using an adhesive for other purposes.

In other fields, such as notes that may be stuck to a surface, a “weak” adhesive may be used that can be used to stick the note multiple times to a surface since the adhesive can be reused multiple times. Thus, it is desirable to provide a facial mask that uses a weak adhesive to completely seal the face and it is to this end that the disclosure is directed.

### BRIEF DESCRIPTION OF THE DRAWINGS

FIGS. 1A and 1B illustrate a first embodiment of a facial mask and a backside of the mask in FIG. 1A, respectively;

FIGS. 2A and 2B illustrate a second embodiment of a facial mask and a backside of the mask in FIG. 2A, respectively;

FIGS. 3A and 3B illustrate a third embodiment of a facial mask and a backside of the mask in FIG. 3A, respectively;

FIGS. 4A and 4B illustrate a fourth embodiment of a facial mask and a backside of the mask in FIG. 4A, respectively;

FIG. 5 is a front view of an exemplary mask;

FIG. 6 illustrates a stack of layers that can be used to form the covering of each mask;

FIG. 7A illustrates the facial mask with hinge in a normal wearing position; and

FIG. 7B illustrates the facial mask with hinge in a folded up position.

### DETAILED DESCRIPTION OF ONE OR MORE EMBODIMENTS

The disclosure is particularly applicable to a face mask that can be used multiple times for protection against Covid 19 and it is in this context that the disclosure will be described. It will be appreciated, however, that the mask may be manufactured of different materials, have different sizes or shapes and have other features that are all within the scope of the disclosure.

The disclosure is directed to a facial mask that completely seals the areas of the face that improves wearing comfort, avoids ear irritations, and creates a complete seal of the mask against the face. The facial mask may be implemented for both non-medical grade (cloth) masks and/or medical-grade (N95 or similar) masks. Furthermore, different materials can also be utilized with this invention to achieve disease-spread-reducing, particulate filtering, fume-reducing, or other goals/criteria. Now, several examples of embodiments of the facial mask will be described.

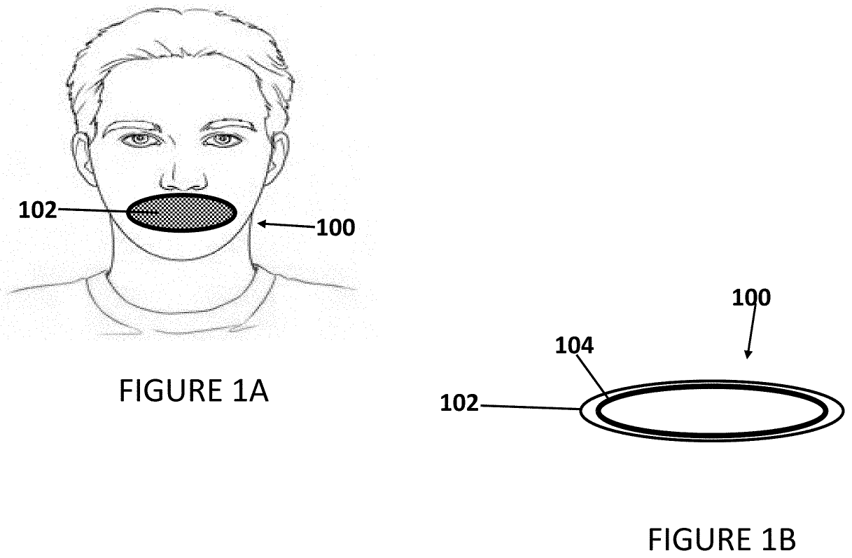

FIGS. 1A and 1B illustrate a first embodiment of a facial mask 100 shown being worn by a user. In this embodiment, the mask 100 covers only the mouth of the user. The mask has a covering portion 102 that filters the air being inhaled and traps particulate and droplets being exhaled by the user through the mouth. Examples of the particular material and one or more layers of the covering portion 102 are described below in more detail. As shown in FIG. 1B, an adhesive 104 encircles the mask near the edge of the mask. Note that the precise distance of the adhesive 104 from the edge of the mask can vary somewhat and a width of the adhesive can vary between about 0.25 inches to 1 inch. In one embodiment, the adhesive is 0.75 inches wide all of the way around a perimeter of the mask. The adhesive may be a weak adhesive (an adhesive that is semi-adhesive allowing the wearer to put-on/take-off or reposition the mask one or more times) and may be in the form of a strip of adhesive that is affixed to the covering portion 102. For example, the adhesive may be double sided and one side is stuck to the covering portion 102, the adhesive may be sewed to the covering portion or attached to a hook and loop structure, such as Velcro or similar material with the purpose of the hook and loop or similar fastener allows the facial mask material/covering to be temporarily remove/replaced by the wearer, with the tape/adhesive continuing to be attached to the face (for example to eat a meal or take a drink). The first side of the adhesive does not release from the covering portion 102 while the other side adhesive is pressed onto the face to secure the mask to the face. When the mask 100 is placed over the mouth of the user, the adhesive 104 sticks to the skin of the user to completely seal the mouth of the user. The adhesive may be manufactured such that it can be easily removed from the face of the user and then replaced onto the face of the user without significantly degrading the stickiness. In one embodiment, the adhesive strip is a commercially available product number 2477P that is manufactured by 3M although the mask may be manufactured using other adhesive strips/tapes.

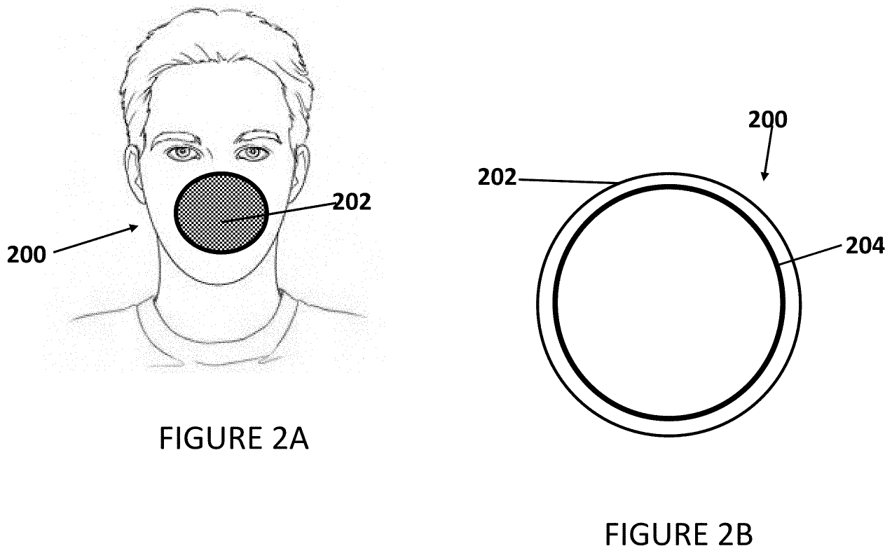

FIGS. 2A and 2B illustrate a second embodiment of a facial mask 200 shown being worn by a user. In this embodiment, the mask 200 covers both the nose and mouth of the user. The mask has a covering portion 202 that filters the air being inhaled and traps particulate and droplets being exhaled by the user through the mouth and/or nose. Examples of the particular material and one or more layers of the covering portion 202 are described below in more detail. As shown in FIG. 2B, an adhesive 204 encircles the mask near the edge of the mask and the distance from the edge of the mask may vary somewhat.

The adhesive may be a weak adhesive and may be in the form of a strip of adhesive that is affixed to the covering portion 202. For example, the adhesive may be double sided and one side is stuck to the covering portion 202, the adhesive may be sewed to the covering portion or attached to a hook and loop structure, such as Velcro or similar material with the purpose of the hook and loop or similar fastener allows the facial mask material/covering to be temporarily remove/replaced by the wearer, with the tape/adhesive continuing to be attached to the face (for example to eat a meal or take a drink). The first side of the adhesive does not release from the covering portion 202 while the other side adhesive is pressed onto the face to secure the mask to the face. When the mask 200 is placed over the mouth and nose of the user, the adhesive 204 sticks to the skin of the user to completely seal the mouth and nose of the user. The adhesive may be manufactured such that it can be easily removed from the face of the user and then replaced onto the face of the user without significantly degrading the stickiness as above.

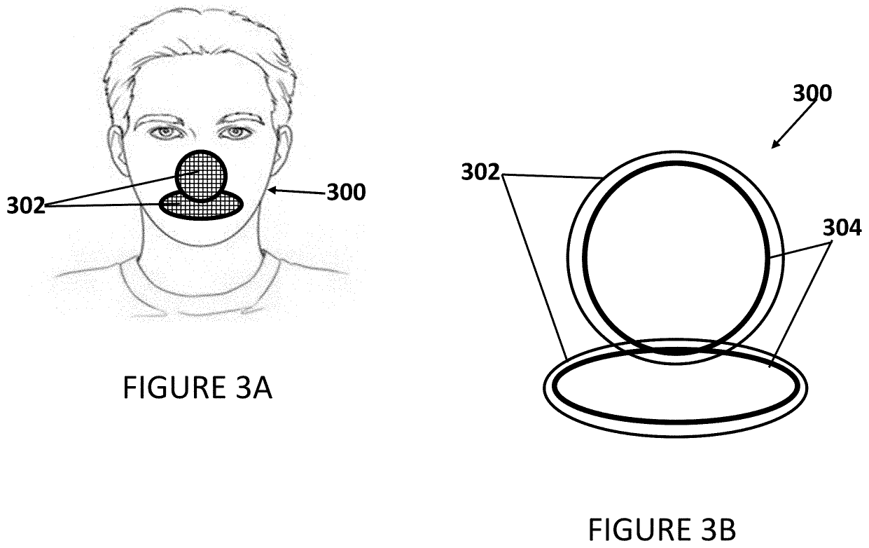

FIGS. 3A and 3B illustrates a third embodiment of a facial mask 300 shown being worn by a user. In this embodiment, the mask 300 covers both the nose and mouth of the user. The mask has a covering portion 302 that filters the air being inhaled and traps particulate and droplets being exhaled by the user through the mouth and/or nose. Examples of the particular material and one or more layers of the covering portion 302 are described below in more detail. As shown in FIG. 3B, an adhesive 304 encircles the mask near the edge of the mask and the distance from the edge of the mask may vary somewhat. In this embodiment, there may also be another piece of adhesive between the nose and mouth for stability.

The adhesive may be a weak adhesive and may be in the form of a strip of adhesive that is affixed to the covering portion 302. For example, the adhesive may be double sided and one side is stuck to the covering portion 302, the adhesive may be sewed to the covering portion or attached to a hook and loop structure, such as Velcro or similar material with the purpose of the hook and loop or similar fastener allows the facial mask material/covering to be temporarily remove/replaced by the wearer, with the tape/adhesive continuing to be attached to the face (for example to eat a meal or take a drink). The first side of the adhesive does not release from the covering portion 302 while the other side adhesive is pressed onto the face to secure the mask to the face. In an alternate embodiment, the adhesive, such as a skin-friendly adhesive, may be sprayed or otherwise deposited onto the skin of the face of the user or directly onto the mask material so that the mask may be completed sealed onto the face of the user. In this alternative embodiment, no adhesive tape/strip is needed to achieve the complete face sealing.

This embodiment of the mask 300 also may have a wire mesh attached into the mask, such as sewn into around the edge of the mask, to provide shape-forming rigidity to the mask 300. The shape forming material may be other materials, such as silicone, plastic, etc. that can hold a shape and may also be used to keep the filter/cloth off of the lips (avoid touching lipstick, make it easier to speak, etc.). When the mask 300 is placed over the mouth and nose of the user, the adhesive 304 sticks to the skin of the user to completely seal the mouth and nose of the user. The adhesive may be manufactured such that it can be easily removed from the face of the user and then replaced onto the face of the user without significantly degrading the stickiness.

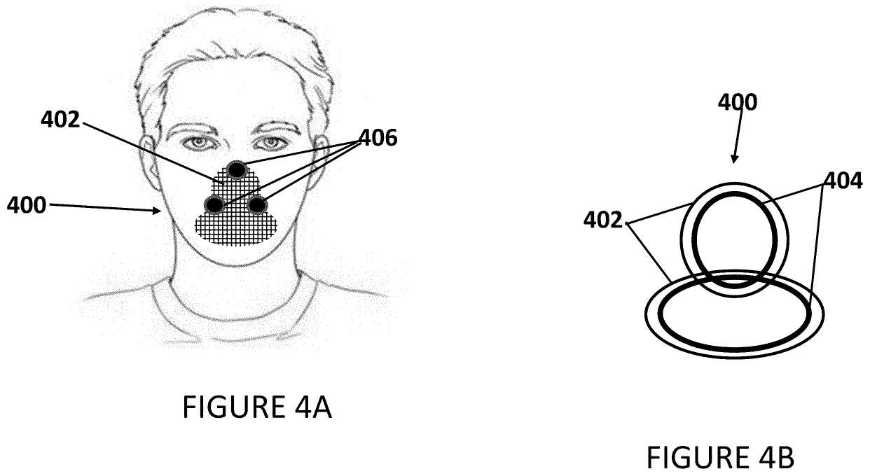

FIGS. 4A and 4B illustrate a fourth embodiment of a facial mask 400 shown being worn by a user. In this embodiment, the mask 400 covers both the nose and mouth of the user. The mask has a covering portion 402 that filters the air being inhaled and traps particulate and droplets being exhaled by the user through the mouth and/or nose. Examples of the particular material and one or more layers of the covering portion 402 are described below in more detail. As shown in FIG. 4B, an adhesive 404 encircles the mask near the edge of the mask and the distance from the edge of the mask may vary somewhat. This embodiment of the mask 400 as shown in FIG. 4A may have one or more additional adhesive anchor points 406, such as the three shown near the two lower corners and near the middle/top of the nose, where a limited adhesive area anchors (attaches) the mask to the face. Alternatively, this embodiment may be attached to the face by just the one or more anchor points 406. The limited number of anchor points 406 allows for the maximum mouth/facial movement (underneath the mask) for talking, eating, or comfort reasons and the facial mask would continue to cover additional parts of the face on a free-floating (non-adhered) basis.

The adhesive may be a weak adhesive and may be in the form of a strip of adhesive that is affixed to the covering portion 402. For example, the adhesive may be double sided and one side is stuck to the covering portion 402, the adhesive may be sewed to the covering portion or attached to a hook and loop structure, such as Velcro or similar material with the purpose of the hook and loop or similar fastener allows the facial mask material/covering to be temporarily remove/replaced by the wearer, with the tape/adhesive continuing to be attached to the face (for example to eat a meal or take a drink). The first side of the adhesive does not release from the covering portion 402 while the other side adhesive is pressed onto the face to secure the mask to the face.

This embodiment of the mask 400 also may have a wire mesh attached into the mask, such as sewn into around the edge of the mask, to provide shape-forming rigidity to the mask 400 that can fit to the 3 dimensional shape of the face. When the mask 400 is placed over the mouth and nose of the user, the adhesive 404 and/or anchor points 406 sticks to the skin of the user to completely seal the mouth and nose of the user. The adhesive may be manufactured such that it can be easily removed from the face of the user and then replaced onto the face of the user without significantly degrading the stickiness.

Each of the embodiments shown in FIGS. 1A-4B do not require straps to secure the mask to the face of the user. However, each of these masks 100-400 may also include straps or may have holes in the mask 100-400 to accommodate a strap. Alternatively, the mask may also have loops or other similar methods to connect an optional strap to the mask.

Furthermore, each embodiment of the mask may have different sizes to accommodate different size and shape faces. For example, the facial mask may have an overall circular, elliptical, oval, square, and/or elliptical shape with both sides curving upwards (to approximate a smile shape), or in any other shape, for example to visually create a company logo (for example a circular body with two “ears” in the upper corners—for example to appear as mouse with two ears shape). As shown in the above figures, the mask may be a single piece or made from two pieces. Also, each embodiment may have advertising on an outside surface of the mask, an image and/or writing on the outside of the mask. Thus, in different embodiments, the mask may have a consistent color across the outside of the mask, different colors, designs, patterns, etc on the visible-to-the-world side of the mask. For example, the outer surface of the mask may have cosmetic patterns, colors, and shapes, such as a brand or company logo, patterns, or shapes.

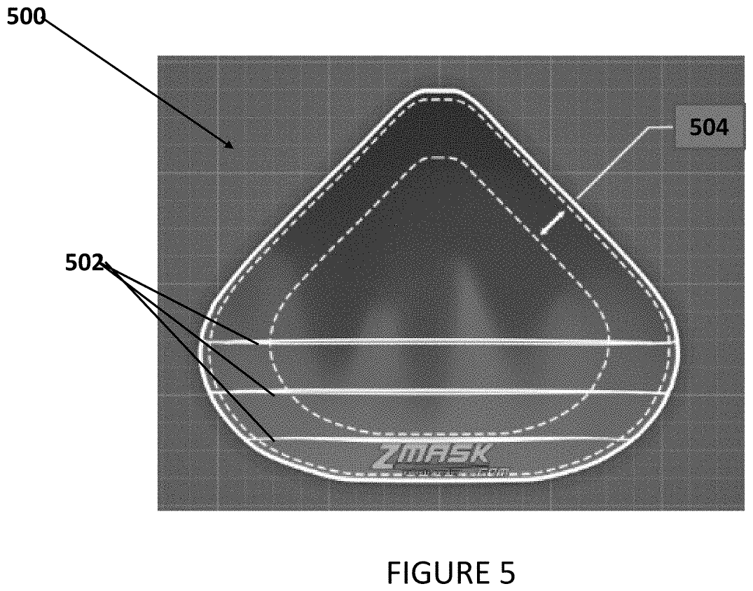

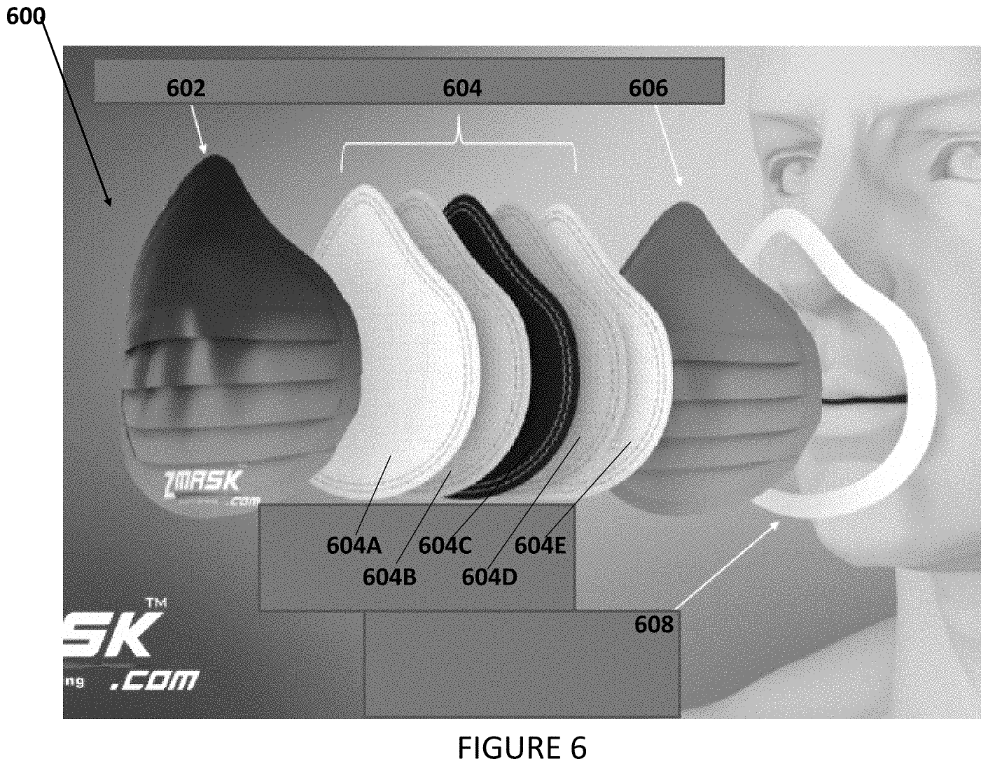

Each of the above masks and the mask shown in FIGS. 5-6 may be made using a double sided adhesive tape as disclosed above. Alternatively, an adhesive may be poured onto the mask to form the adhesive that adheres to the face of the user. In some embodiments, the adhesive may be flexible and stretchy so that, for example, a user can open his/her mouth and the mask will remain attached to the face of the user. In some embodiments, the silicon adhesive may be stretchy although the amount of stretch may be dependent on the tape material itself.

In some embodiments, the mask may have the adhesive or “tape” on the outside-side of the mask, positioned such that the single-sided tape approximately half covers the facial mask material, with some of the tape extending beyond the edge of the mask, allowing the tape material to then adhere to the skin outside of the area covered by the facial mask material.

Each of these masks 100-400 may be made of a typical mask material, such as a fine mesh of synthetic polymer fibers, such as a nonwoven polypropylene fabric. Each mask 100-400 may also be made of a cloth material and may have one or more folds in the mask that allows the mask to expand to accommodate a wider range of face sizes or to accommodate stretching/expansion of the mask. Alternatively, each mask 100-400 may be made of material that itself may contain one or more folds to accommodate stretching/expansion.

Each of the embodiments of the mask above or shown in FIGS. 5-6 may be transparent, semi-transparent and/or non-transparent. In various embodiments, the facial mask and the adhesive may be water-proof or water-resistant to allow the wearer to wear the mask in the rain, etc. In another embodiment, the facial mask along with the adhesive/adhering mechanism is not water-proof or water-resistant.

In one embodiment, any of the masks may be folded/sewn in areas so the facial mask may be shipped/stored flat or minimal height. Then, when the mask is applied to the face the folded areas unfold to better cover to the typical contours of the nose/mouth of the user. The masks may have a Caucasian skin color on an outside surface of the mask. In other embodiments, the mask may come in different colors to better blend with black, dark, or other colors and shades to match the wide-variety of human face color/tones.

FIG. 5 is a front view of an exemplary mask 500. This mask may be made of a cloth material and may have one or more folds that allows the bottom of the mask 500 to adjust in size. In this embodiment, an adhesive strip 504 may encircle the mask 500 to seal the mask to the face and the adhesive strip may be 0.75″ wide and may be very close to the edge of the mask. The placement of the adhesive 504 provide a sealed pocket inside of the mask in which the nose and mouth of the user are located. FIG. 5 also shows an example of advertising being placed on the outside of the mask surface.

FIG. 6 illustrates a mask 600 having a stack of layers that can be used to form the covering of the mask. Note that this stack of layers in FIG. 6 may be used with all of the other mask embodiments described above. In the example in FIG. 6, the mask 600 has one or more folds, but the stack of layers may be employed in the masks the do not have the one or more folds. As shown in FIG. 6, the stack may include an outer covering 602 on which advertising, an image, text may be placed, and the outer covering may have various colors. The stack may also have a filter element 604 that may be replaceable and an inner covering 606 that separates the face of the user from the filter element 604. The filter element 604 may be a single use filter or a five layer replaceable filter. As before, the mask may also have an adhesive strip 608 that may be two sided and replaceable. In one embodiment, the adhesive strip 608 may have a skin side that is skin-friendly, non-irritating adhesive, such as an FDA approved silicon adhesive, and a mask side adhesive that is an acrylic adhesive. An inner layer between the two adhesive sides may be a polymer strip. The adhesive strip may have peel and stick paper coverings on both adhesive sides.

In some embodiments, the filter element 604 may further comprise an anti-sticking cloth 604A, a first stage filter 604B, an activated carbon layer 604C, a second stage filter 604D and a second anti-sticking cloth 604E that are stacked together and are replaceable. The filter element 604 may typically be available commercially as a pre-manufactured “sandwich” of the multiple layers 604A-604E. Then, the “filter” pre-manufactured with the five layers is replaced. In other embodiments, the filter element 604 may have more or fewer layers, may have a different type or types of active layers (carbon or otherwise), and the filter element 604 and its constituent layers/parts may be adjusted depending on the target particles (virus, smoke, fumes, dust particles, etc.). being filtered. Furthermore, the filter layers may be made from electro-cloth filters, nano-filters, HEPA filters, silver-based filters, etc.

As an alternative embodiment to the embodiments shown above in which the adhesive bond/strip goes around the periphery of the mask, the mask may form a complete face seal with the combination of adhesives and other materials. For example, the mask may have a combination of adhesives in some portions of the face-to-mask seal and non-adhesive but air-blocking insulators (1-sided sticky foam for example) in other parts. For example, the mask forms the tight, complete seal in which adhesives are used for some portions of the seal as it goes around the face and then the insulators, such as piece of foam with one side having an adhesive to adhere to the covering, may be used to “fill in the gaps” between sections of adhesive as the seal goes around the face. As another alternative, the adhesives form an incomplete face seal to hold the mask on to the face, but not necessarily to form an air-tight seal. For example, there could be 4 or 5 adhesive points which hold the cloth covering on to the face and holds it in place over the nose/mouth, and forms a majority seal but not necessarily an “air tight” seal.

In some embodiments, the mask may include one or more valve or other air-flow limiting or switching device (to allow for greater unidirectional airflow rates). In some embodiments, the facial mask covering may extend over the skin slightly past the adhesive area/region to allow for a finger to easily grab this extra “tab” to allow easy mask removal from the face. For example, such a tab be placed along the bottom (chin-facing) side of the mask.

In some embodiment, the facial mask have “shape forming” material added to, in, formed on or attached to the face mask covering material, to aid in the covering conforming to either a pre-formed shape (i.e. the 3 dimensional shape around the nose), or user-conformed shape. Such “shape forming” forming materials may be continuous, semi-continuous, or limited (strips), in one multiple directions (for example in a mesh combined of multiple strips in parallel and/or different directions) to allow the user to conform (custom shape) the mask to a rigid, or semi-rigid, or shape to customize the mask to conform to that user's face shape. Such “shape additive” material could be composed of one or more metal areas, wire mesh (similar to a metal wire fence) metal, plastic, or other bendable materials, either pre-formed at the factory to a standard facial shape, or with user-formable materials to allow the user to custom-shape the semi-rigid material to the custom size/shape of his/her face. The facial mask may have any combination of one or more of the above shapes, colors, valves, and/or features, elements, adhesives or adhesive mechanisms.

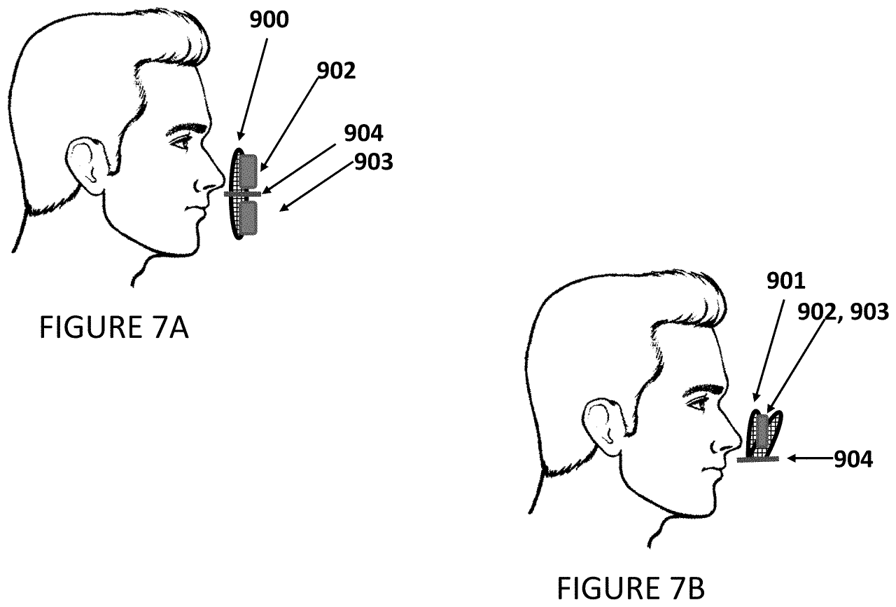

In some embodiments, the facial mask may have one or more “hinge points” added to the filtering material, on, or attached to the face mask covering material, to aid in the temporary lift up/away from the mouth, for purposes of eating, drinking, talking on the phone, etc. FIG. 7A illustrates the facial mask with hinge in a normal wearing position and FIG. 7B illustrates the facial mask with hinge in a folded up position. The facial mask 900 may have a horizontal crease 904, that may be pre-folded, approximately halfway down the mask 900 and one or more attachment mechanisms 902, 903, such as hook and loop materials, such as 3M branch Velcro or other attachment mechanisms that are attached to the mask and used to hold the mask in the folded up position as shown in FIG. 7B (to allow eating or drinking, etc. by the user without having to completely remove the facial mask). The horizontal crease 904 allows the mask material to easily fold at the crease line. The attachment mechanisms 902, 903 are attached to the mask in positions such that when the lower-half of the mask is folded in the “folded up” position, along the crease line, that the two piece of the attachment mechanism 902, 903 (as shown in FIG. 7B) connect with each other and hold the lower half of the mask up against the upper half of the mask, enabling the wearer to eat or drink, exposing this mouth. In some embodiments, there may be one or more attachment mechanisms.

The foregoing description, for purpose of explanation, has been with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include and/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general-purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software, and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

What is claimed is:

1. A facial mask, comprising:
a covering having a shape with a periphery;
an adhesive that is around at least part of the periphery of the covering; and
wherein the adhesive completely seals the covering over a face portion when the facial mask is placed onto the face portion and wherein the facial mask is removable and positionable back onto the face portion to completely seal the covering over the face portion.

2. The facial mask of claim 1, wherein the face portion is a mouth of a user and the covering completely seals over the mouth of the user.

3. The facial mask of claim 1, wherein the face portion is a mouth and a nose of a user and the covering completely seals over the mouth and nose of the user.

4. The facial mask of claim 1, wherein the covering further comprises a first covering and a second covering wherein each of the first and second coverings completely seal a different part of the face portion.

5. The facial mask of claim 1 further comprises at least one strap that fits around one of an ear and a head of the user.

6. The facial mask of claim 1, wherein the covering has one or more holes that accommodate a strap.

7. The facial mask of claim 1, wherein the covering has a filter.

8. The facial mask of claim 7, wherein the filter is replaceable.

9. The facial mask of claim 8, wherein the filter further comprises a plurality of layers.

10. The facial mask of claim 9, wherein the plurality of layers comprises a first stage filter, a second stage filter and an activated carbon layer in between the first and second stage filters.

11. The facial mask of claim 10, wherein the plurality of layers further comprises a first and second anti-sticking cloth at each end of the plurality of layers.

12. The facial mask of claim 1, wherein the covering is made of cloth and has one or more folds in the covering.

13. The facial mask of claim 1, wherein the covering has advertising on an outer surface of the covering.

14. The facial mask of claim 1, wherein the adhesive surrounds the entire periphery of the covering.

15. The facial mask of claim 1 further comprising one or more air-blocking insulators at other parts along the periphery of the covering wherein the adhesive and the one or more air-blocking insulators form the complete seal.

16. The facial mask of claim 1, wherein the adhesive is a double-sided adhesive tape.

17. The facial mask of claim 1 further comprising one or more adhesive anchor points attached to the covering.

18. The facial mask of claim 1, wherein the adhesive further comprises one or more adhesive anchor points around the periphery of the covering.

19. A facial mask, comprising:
a covering having a shape with a periphery;
an adhesive that is around at least part of the periphery of the covering; and
wherein the adhesive removably secures the covering over a face portion when the facial mask is placed onto the face portion.

20. The facial mask of claim 19, wherein the face portion is a mouth of a user and the covering covers the mouth of the user.

21. The facial mask of claim 19, wherein the face portion is a mouth and a nose of a user and the covering covers the mouth and nose of the user.

22. The facial mask of claim 19, wherein the covering further comprises a first covering and a second covering wherein each of the first and second coverings covers a different part of the face portion.

23. The facial mask of claim 19 further comprises at least one strap that fits around one of an ear and a head of the user.

24. The facial mask of claim 19, wherein the covering has one or more holes that accommodate a strap.

25. The facial mask of claim 19, wherein the covering has a filter.

26. The facial mask of claim 25, wherein the filter is replaceable.

27. The facial mask of claim 26, wherein the filter further comprises a plurality of layers.

28. The facial mask of claim 27, wherein the plurality of layers comprises a first stage filter, a second stage filter and an activated carbon layer in between the first and second stage filters.

29. The facial mask of claim 28, wherein the plurality of layers further comprises a first and second anti-sticking cloth at each end of the plurality of layers.

30. The facial mask of claim 19, wherein the covering is made of cloth and has one or more folds in the covering.

31. The facial mask of claim 19, wherein the covering has advertising on an outer surface of the covering.

32. The facial mask of claim 19, wherein the adhesive surrounds the entire periphery of the covering.

33. The facial mask of claim 19 further comprising one or more air-blocking insulators at other parts along the periphery of the covering wherein the adhesive and the one or more air-blocking insulators adhere the covering to the face portion.

34. The facial mask of claim 19, wherein the adhesive is a double-sided adhesive tape.

35. The facial mask of claim 19 further comprising one or more adhesive anchor points attached to the covering.

36. The facial mask of claim 19, wherein the adhesive further comprises one or more adhesive anchor points.
